(19) United States
(12) Patent Application Publication
(10) Pub. No.: US 2024/0358013 A1
(43) Pub. Date: Oct. 31, 2024

(54) COMPOSITIONS AND METHODS FOR IMPROVING SEED FLOWABILITY AND ENHANCING PLANT GROWTH

(71) Applicant: Kannar Earth Science, Ltd., Lawrenceville, GA (US)

(72) Inventors: Samuel L. Cloete, Suwanee, GA (US); Ahsan Habib, Lawrenceville, GA (US); Heather Lewis, Duluth, GA (US)

(21) Appl. No.: 18/767,160

(22) Filed: Jul. 9, 2024

Related U.S. Application Data
(63) Continuation of application No. PCT/US23/60347, filed on Jan. 10, 2023.
(60) Provisional application No. 63/304,038, filed on Jan. 28, 2022.
(60) Provisional application No. 63/266,607, filed on Jan. 10, 2022.

(51) Int. Cl. A01N 25/10; A01C 1/06; A01N 37/44; A01N 43/08; A01N 43/16; A01N 43/78; A01P 21/00

(52) U.S. Cl. CPC A01N 25/10; A01C 1/06; A01N 37/44; A01N 43/08; A01N 43/16; A01N 43/78; A01P 21/00

(57) ABSTRACT

Dry seed flow lubricant compositions are provided for improving seed appearance and flowability. The lubricant compositions include about 5% to about 100% by weight cellulose-based polymer in place of commonly used lubricants such as talc, graphite, or plant protein powder. Advantages of the lubricant compositions include that they are non-toxic, microplastic free, and biodegradable to provide a carbon source for plant growth and have an increased shelf life relative to plant oils that can become rancid over time. In addition, seed performance compositions are provided that reduce days to germination, increase germination rate, and/or increase plant growth. The seed performance compositions counteract negative effects on plant growth that can occur from seed treatment with pesticides. Dry compositions are also provided that include a combination of a seed flow lubricant and a seed performance additive to improve seed flowability and improve seed germination and growth.

### CROSS-REFERENCE TO RELATED APPLICATION

This application is a continuation of International patent application no. PCT/US2023/060347 filed on Jan. 10, 2023, which claims the benefit of priority of U.S. provisional patent application No. 63/266,607 filed on Jan. 10, 2022, and U.S. provisional patent application No. 63/304,038 filed on Jan. 28, 2022, each of which is incorporated herein in its entirety by this reference.

### TECHNICAL FIELD

The present disclosure relates to the field of seed treatment in agriculture with compositions that improve seed flowability through planting equipment and/or promote plant growth.

### BACKGROUND

Agricultural seed is often treated with biological agents and/or pesticides that protect the seeds from pests and disease. Seeding equipment such as planters and seed drills has evolved to the point that seeds can be singulated and planted precisely with respect to depth, spacing, population, and seed orientation within the soil. However, treated seed tends to flow and handle differently than untreated seed. Typically, treated seed does not flow as well through seeding/planting devices and residue can build up on equipment surfaces. As a result, powdered seed lubricants are added to seed treatment formulations to improve seed flow and reduce wear on seeding equipment. Common powdered seed lubricants include talc, graphite, or plant protein powder as a fluency aid. However, these common lubricants have limited plant growth response during seed germination in the field.

Therefore, a need remains for seed lubricant compositions that are non-toxic and microplastic free and that can improve plant growth response. The present disclosure provides such compositions and methods for use thereof.

### SUMMARY

In some aspects of the present invention, dry compositions for use as a plant seed flow lubricant are provided that include about 5% to about 100% by weight cellulose-based polymer as a lubricant, wherein the dry composition excludes talc, graphite, and protein powder.

In some embodiments, plant seed coated with a composition of the invention is provided, the composition including about 5% to about 100% by weight cellulose-based polymer, wherein the dry composition excludes talc, graphite, and protein powder.

In other aspects, microbial compositions are provided that include about 99% by weight cellulose-based polymer and about 1% or less microbes.

In one instance, a method is provided for improving plant seed flowability, the method including contacting plant seed with a composition comprising about 5% to about 100% by weight cellulose-based polymer as a lubricant, wherein the dry composition excludes talc, graphite, and protein powder. In the method, the plant seed can be mixed, vibrated, or agitated during the contacting. The contacting may occur in a seed planter box or prior to addition of the seed to a seed planter box. The composition may be contacted with the plant seed in a weight ratio from about 0.0001:1 to about 0.5:1. In some instances, the composition is contacted with the seed in an amount ranging from about 0.5 ounces per 100 pounds of seed to about 5 ounces per 100 pounds of seed.

In one aspect of the invention, a composition is provided for improved handling and seed coating properties, the composition including up to 99% by weight cellulose-based polymer and micronutrients or other crop establishment aids.

In various embodiments of the compositions, plant seed, or methods of the invention, the cellulose-based polymer is hydroxyethylcellulose or methyl cellulose.

In various embodiments of the compositions, plant seed, or methods of the invention, the composition can further include one or more nutrients, plant growth promoters, or pesticides.

In other embodiments, plant growth promoting compositions are provided. The plant growth promoting composition can include: one or a combination of vitamin E, B1, and C; glutathione: optionally, a flavanone glycoside; and optionally, one or more biostimulants, The compositions can improve one or more metric of seed performance including reducing days to germination, increasing germination rate, or increasing plant growth.

In one aspect, the plant growth promoting composition includes about 52.6% by weight of vitamin E, about 26% by weight of Vitamin B1, about 10.5% by weight of Vitamin C, and about 10.5% by weight of glutathione.

In one instance, the plant growth promoting composition includes about 43.5% by weight of vitamin E, about 21.7% by weight of Vitamin B1, about 8.7% by weight of Vitamin C, about 8% by weight of glutathione, about 8.7% by weight of L-Tryptophan, and about 8.7% by weight of Potassium Humate.

In one aspect, the plant growth promoting composition includes about 37% by weight of vitamin E, about 18.5% by weight of Vitamin B1, about 7.4% by weight of glutathione, and about 37% by weight of isoflavonoid Hesperidin.

In another instance, the plant growth promoting composition includes about 37% by weight of vitamin E, about 18.5% by weight of Vitamin B1, about 7.4% by weight of glutathione, and about 37% by weight of Potassium Humate.

In one instance, the plant growth promoting composition includes about 35.7% by weight of vitamin E, about 17.8% by weight of Vitamin B1, about 3.5% by weight of Vitamin C, about 7% by weight of glutathione, and about 35.7% by weight of L-Tryptophan.

In some aspects of the present invention, a dry composition is provided for use in plant growth promotion. Specifically, a dry composition is provided including: a seed flow lubricant and a seed performance additive, wherein the seed performance additive comprises: one or a combination of vitamin E, B1, and C: glutathione: optionally, a flavanone glycoside; and optionally, one or more biostimulants. The dry composition can improve one or more metric of seed performance including reducing days to germination, increasing germination rate, and increasing plant growth. The composition can include about 1.5-5% or about 3-5% of the seed performance additive and the rest of the about 95-98.5% or about 95-97% by weight, respectively, can include the seed flow lubricant. The lubricant can be a dry cellulose-based polymer, protein powder, plant protein powder, talc, or graphite, and combinations thereof. The cellulose-based polymer can include one or more of hydroxyethyl cellulose (HEC), hydroxyethyl propyl methyl cellulose (HPMC), quillaja extract xanthan gum, or yucca extract, and combinations thereof.

In one instance, a method is provided for improving plant response with a composition comprising about 3.4% by weight of seed performance additive #1 (Table 3) and about 96.6% by weight cellulose-based polymer or protein powder as a lubricant.

In one instance, a method is provided for improving plant response with a composition comprising about 4% by weight of seed performance additive #2 (Table 3) and about 96% by weight cellulose-based polymer or protein powder as a lubricant.

In other instances, methods are provided for improving plant response with a composition comprising about 5% by weight of seed performance additive #3, #4, or #5 (Table 3) and about 96% by weight cellulose-based polymer or protein powder as a lubricant.

In the methods for improving plant response, the plant seed can be mixed, vibrated, or agitated during the contacting. The contacting may occur in a seed planter box or prior to addition of the seed to a seed planter box.

In one embodiment, a method is provided for improving seed performance, including planting a seed treated with a composition that includes any of the plant growth promoting compositions described herein in a suitable growing medium, wherein the plant growth promoting composition is present in an amount that improves a metric of seed performance including reducing days to germination, increasing germination rate, and increasing plant growth.

In another embodiment, a method is provided for improving one or both of plant growth and health, including delivering to seed of a plant, roots of a plant, or soil or growth medium surrounding a plant, any of the plant growth promoting compositions described herein, wherein the composition is present in an amount that improves one or more metric of seed performance including reducing days to germination, increasing germination rate, or increasing plant growth.

In various embodiments of the compositions, plant seed, or methods of the invention, the composition can further include one or more nutrients, plant growth promoters, antioxidants, vitamins, mycorrhizae, microbes, or pesticides.

In various methods of the invention, the seed can include seeds from soy bean, peanut, corn, legume plants, cereal, grass, cotton, oil, or vegetable plants, and combinations thereof.

### BRIEF DESCRIPTION OF THE DRAWINGS

FIG. 1 is an image showing the front of a flowability funnels apparatus used to compare the flowability of test and control compositions according to one or more embodiments of the present disclosure.

FIG. 2 is a top view image of the flowability funnels apparatus shown in FIG. 1.

FIG. 3A is an image of soybean seed treated with a control dry seed finisher composition that is a product that contains soy protein powder and soy lecithin component as a lubricant to aid in flowability.

FIG. 3B is an image of soybean seed treated with a test dry seed finisher composition that is the same product formulation as in FIG. 3A except that the soy protein powder and soy lecithin component was replaced with the cellulose-based polymer hydroxyethyl cellulose.

FIG. 4 is an image showing germinated soybean seed first treated with a liquid inert control and then: not treated with a dry powder composition (None), treated with protein powder alone (Protein Powder), treated with dry hydroxyethyl cellulose alone (HEC), or treated with a dry composition including about 95-96.4% hydroxyethyl cellulose and about 3.4-5% of one of seed performance compositions #1− #5 from Tables 3 and 4 (HEC+ #1: HEC+ #2; HEC+ #3; HEC+ #4: HEC+ #5).

FIG. 5 is an image showing germinated cotton seed first treated with a custom liquid blend of industry standard pesticide and then treated with either protein powder alone (DUST) or treated with a composition including about 95-96.4% protein powder DUST and about 3.4-5% of one of seed performance dry compositions #1− #5 from Tables 3 and 4 (DUST+ #1: DUST+ #2: DUST+ #3: DUST+ #4: DUST+ #5).

FIG. 6A is an image showing germinated soy bean seed seven days after treatment with a liquid water control followed by treatment with protein powder alone (DUST) or treatment with a dry composition including about 95-96.4% DUST and about 3.4-5% of seed performance composition #2 (DUST+ #2) or #3 (DUST+ #3) from Tables 3 and 4.

FIG. 6B is an image showing germinated soybean seed seven days after treatment with a liquid blend of industry pesticides followed by no dry powder treatment (No DUST), treatment with protein powder alone (DUST), or treatment with a dry composition including about 95-96.4% DUST and about 3.4-5% of seed performance composition #3 (DUST+#3) from Tables 3 and 4.

FIG. 7A is an image showing germinated wheat seed seven days after treatment with a liquid water control followed by treatment with protein powder alone (DUST) or treatment with a dry composition including about 95-96.4% DUST and about 3.4-5% of seed performance composition #1 (DUST+ #1) or #3 (DUST+ #3) from Tables 3 and 4.

FIG. 7B is an image showing germinated pea seed seven days after treatment with a liquid water control followed by treatment with protein powder alone (DUST) or treatment with a dry composition including about 95% DUST and about 5% of seed performance composition #3 (DUST+ #3) from Tables 3 and 4.

FIG. 7C is an image showing germinated corn seed seven days after treatment with a liquid water control followed by treatment with protein powder alone (DUST) or treatment with a dry composition including about 96% DUST and about 4% of seed performance composition #2 (DUST+ #2) from Tables 3 and 4.

FIG. 8 is a graph showing the effect on peanut yield in a field trial of seed treated with a liquid fungicide from Syngenta alone (Syngenta), with the Syngenta fungicide followed by treatment with seed performance dry composition #2 from Table 3 (Syngenta+ #2), or with the Syngenta fungicide followed by treatment with seed performance dry composition #3 from Table 3 (Syngenta+ #3).

FIG. 9 is a graph showing the effect on peanut yield in a field trial of seed treated with a liquid fungicide from RANCONA VPL alone (RANCONA VPL), with the RANCONA VPL fungicide followed by treatment with seed performance dry composition #2 from Table 3 (RANCONA VPL+ #2), or with the RANCONA VPL fungicide followed by treatment with seed performance dry composition #3 from Table 3 (RANCONA VPL+#3).

### DETAILED DESCRIPTION

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

In various embodiments, the present disclosure provides seed flow lubricant compositions that improve seed appearance and flowability. In one aspect, dry lubricant compositions are provided for coating plant seed that include about 5% to about 100% by weight cellulose-based polymer as a lubricant in place of commonly used lubricants such as talc, graphite, or plant protein powders. The dry compositions for use as plant seed flow lubricants exclude talc, graphite, and protein powder. The dry compositions can include about 5% to about 20% by weight cellulose-based polymer or about 95% to about 97% by weight cellulose-based polymer.

The cellulose-based polymer of the present disclosure can include, but is not limited to, one or more of hydroxyethyl cellulose (HEC), hydroxyethyl propyl methyl cellulose (HPMC), quillaja extract xanthan gum, or yucca extract, and combinations thereof.

The advantages of the dry plant seed lubricant compositions of the present invention include that they are non-toxic, microplastic free, and biodegradable to provide a carbon source for plant growth, can reduce drying time for liquid treated seed, and have an increased shelf life relative to seed lubricant compositions based on plant oils that can become rancid over time.

Experimental results of testing the dry compositions for use as plant seed lubricants and for improving the appearance of seed are described herein in Examples 1-4.

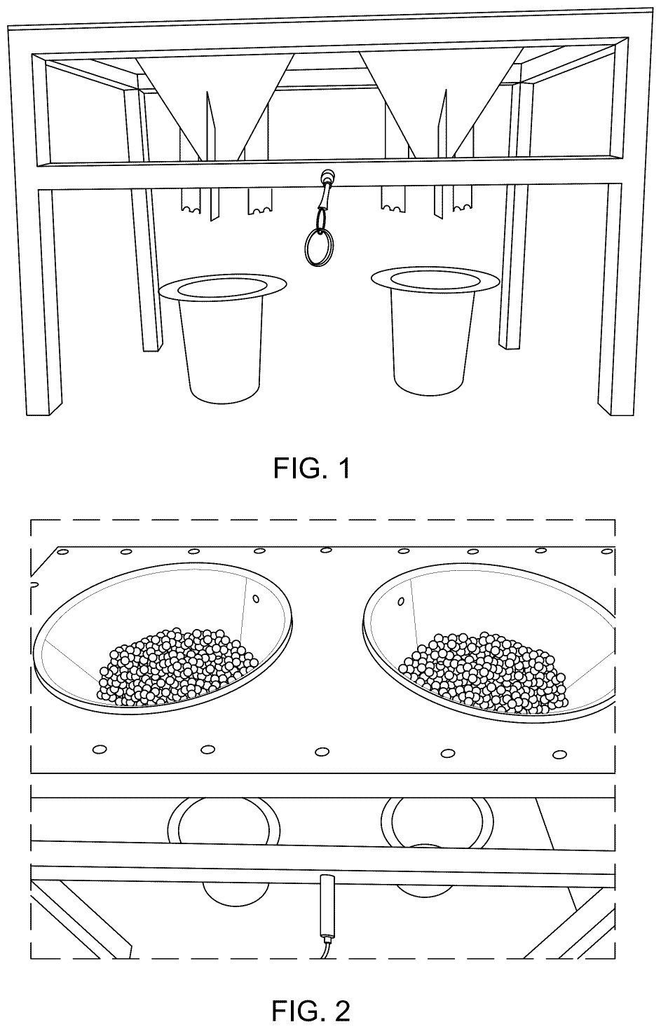

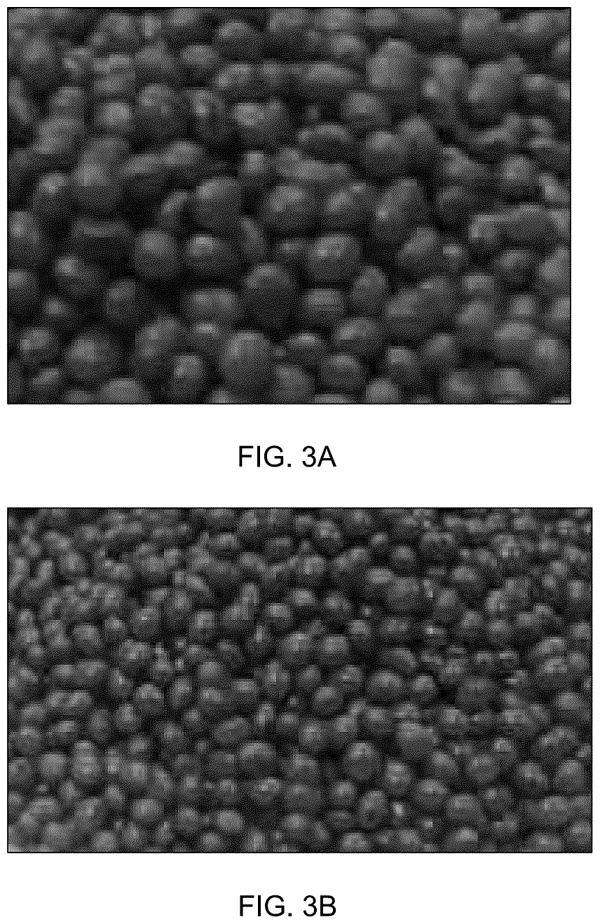

Specifically, Example 1 describes experiments demonstrating that when the cellulose-based polymer hydroxyethyl cellulose (HEC) is substituted for the soy protein powder and soy lecithin component in a commercially available a dry seed finisher, seed treated with this composition flowed through a funnel apparatus faster than seed treated with the commercially available seed finisher. The results are shown in Table 1 and a front and top view of the flowability funnels apparatus that was used is shown in FIG. 1 and FIG. 2, respectively. In addition, the HEC-substituted composition improved the appearance of the treated seed relative to the commercial product (FIGS. 3A & 3B). These results show that cellulose-based fiber can function as a seed flow lubricant composition as well or better than talc, graphite, soybean protein powder and other plant protein powders generally used in the industry.

Example 2 describes a similar experiment using peanut seed, a different liquid base treatment, and where the control dry seed finisher was a different product formulation than in Example 1 that also contained soy protein powder and soy lecithin as a lubricant to aid flowability. The test formulation contained the same formulation except that the soy protein powder and soy lecithin component was replaced with hydroxyethyl cellulose. The appearance of the peanut seed that was treated with the dry seed finisher containing hydroxyethyl cellulose was not noticeably less shiny than the seed treated with control formulation containing soy protein powder and soy lecithin (image not shown).

Example 3 describes experiments in which soybean seed was treated first with a liquid pesticide blend and then with a flowability aid consisting of either cellulose-based polymer, soy protein powder, or a 50/50 mixture thereof. Four trial tests for flowability of the treated seed were performed as described in Examples 1 and 2. In Trial 1, the entry that utilized a 50/50 blend of Hydroxy Ethyl Cellulose and Soy Protein flowed 0.06 Seconds faster than the entry utilizing 100% Soy Protein. In Trial 2, the entry that utilized a 50/50 blend of Hydroxy Ethyl Cellulose and Soy Protein flowed 0.06 Seconds faster than the entry utilizing 100% Soy Protein. In Trial 3, the entry that utilized Hydroxy Ethyl Cellulose flowed 1.10 Seconds faster than the entry utilizing a 50/50 blend of Hydroxy Ethyl Cellulose and Soy Protein. In Trial 4, the entry that utilized Hydroxy Ethyl Cellulose flowed 0.77 Seconds faster than the entry that utilized Soy Protein. The results show that cellulose-based fiber can perform better than protein powder as a seed flow lubricant.

Example 4 describes similar flowability studies to those described for Examples 1-3 using corn seed first treated with a liquid pesticide blend. The treated corn seed was then treated with different dry seed finisher compositions including cellulose-based polymers hydroxyethyl cellulose, corn starch, and hydroxypropyl methyl cellulose and comparative flowability tests were performed in six different trials. In Trial 1, the entry that utilized Soy Protein flowed 2 Seconds faster than the entry that utilized no fluency aid. In Trial 2, the entry that utilized Hydroxy Ethyl Cellulose flowed 1 Second faster than the entry that utilized Soy Protein. In Trial 3, the entry that utilized Hydroxy Ethyl Cellulose flowed 1 Second faster than the entry that utilized Talc. In Trial 4, the entry that utilized Corn Starch flowed 1 Second faster than the entry that utilized Talc. In Trial 5, the entry that utilized Hydroxy-Propyl-Methyl-Cellulose flowed 1 Second faster than the entry that utilized Soy Protein. In Trial 6, the entry that utilized Hydroxy-Propyl-Methyl-Cellulose flowed 4 seconds faster than the entry that utilized talc. The entries that utilized a cellulose-based flowability aid consistently performed as well as or better than industry standard flowability aids Talc and Soy Protein (see U.S. Pat. No. 10,426,077 for soy protein composition).

In addition to the seed flow lubricant compositions described above, plant seeds coated with the seed flow lubricant compositions are also provided herein.

In other embodiments, a method is provided for improving plant seed flowability that includes contacting plant seed with a dry composition comprising about 5% to about 100% by weight cellulose-based polymer as a seed flow lubricant, wherein the dry composition excludes talc, graphite, and protein powder. The plant seed can be being mixed, vibrated, or agitated during the contacting. The contacting can occur in a seed planter box or prior to addition of the seed to a seed planter box.

In the method, the dry composition can include about 5% to about 20% by weight cellulose-based polymer or about 95% to about 97% by weight cellulose-based polymer.

The dry composition can be contacted with the plant seed in a weight ratio from about 0.0001:1 to about 0.5:1.

The dry composition can be contacted with the plant seed in an amount ranging from about 0.5 ounces per 100 pounds of seed to about 5 ounces per 100 pounds of seed.

In the method, the plant seed can include, but is not limited to, soybean, peanut, corn, cotton, pea, wheat, cereal, grass, oil, legumes, non-legumes, or vegetable plants, and combinations thereof.

In other embodiments, dry microbial compositions are provided, the compositions including about 99% by weight cellulose-based polymer and about 1% or less microbes such as, for example, microbes that are plant growth promoters or microbes that are biopesticides. The dry microbial compositions have improved handling properties when used as an example for seed treatment.

In other embodiments of the present disclosure, seed performance compositions are provided as plant growth promoting agents. The seed performance compositions can be used to counteract the negative effects on growth that can occur when seed is treated with chemical pesticides. In addition to the seed performance compositions, a method of making the compositions by combining the specific dry powder components (including, but not limited to, the dry powder components shown in Table 2 in Example 5) of the compositions is also provided herein. Seed performance additive compositions prepared using a specific percent dry weight of the powders listed in Table 2 are shown in Table 3 and identified as compositions #1 through #5 (see Example 5). The terms “seed performance composition”. “seed performance additive”, “seed performance additive composition”, “plant growth promoting composition”, and “seed growth promoting composition” are used herein interchangeably for the purposed of the specification and claims. The terms “composition” and “formulation” are also used herein interchangeably.

In some instances, dry compositions are provided that include a seed performance composition in combination with a dry seed lubricant. The dry seed lubricant can be a cellulose-based polymer such as, for example, hydroxyethyl cellulose (HEC) or a protein powder such as, for example, the product DUST sold by Low Mu Tech. See, for example, U.S. Pat. No. 10,426,077, which is herein incorporated by reference in its entirety, for protein powder seed lubricants. Table 4 in Example 5 shows a list of dry compositions that are included in the present disclosure having a seed performance composition in combination with a dry seed lubricant. The terms “cellulose-based polymer” and “cellulosic polymer” are herein used interchangeably for the purposes of the specification and claims. The cellulose-based polymers of the present disclosure include, but are not limited to, hydroxyethyl cellulose, hydroxyethyl propyl methyl cellulose (HPMC), quillaja extract xanthan gum. yucca extract, and combinations thereof.

A method of making the dry compositions that include a seed performance composition in combination with a dry seed lubricant is also provided herein, the method including combining each of the specific dry powder components (including, but not limited to, the dry powder components shown in Table 2 in Example 5) of the dry compositions.

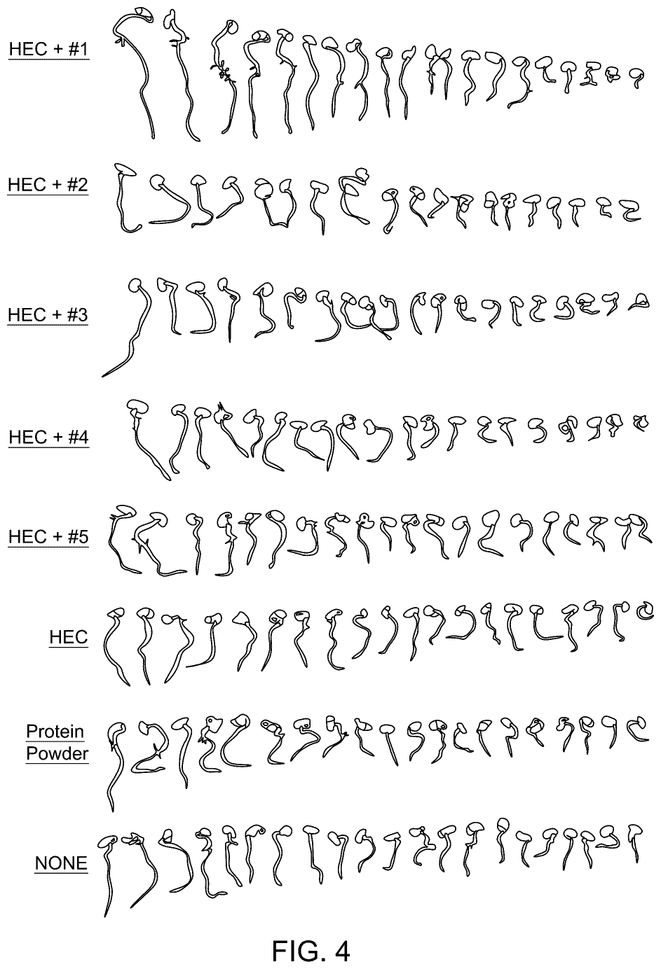

In some embodiments, the seed performance compositions #1− #5 shown in Table 3 are provided for use in combination with either the cellulose-based polymer HEC or with the protein powder DUST for application as a finishing agent to seed treated with liquid blends such as liquid blends of pesticides. In other embodiments, the seed performance compositions #1− #5 shown in Table 3 are provided for use in combination with a different seed flow lubricant. Specific examples of the use of the dry compositions shown in Table 4 are described in Examples 6-8 herein below. The experimental results are illustrated in FIGS. 4-9.

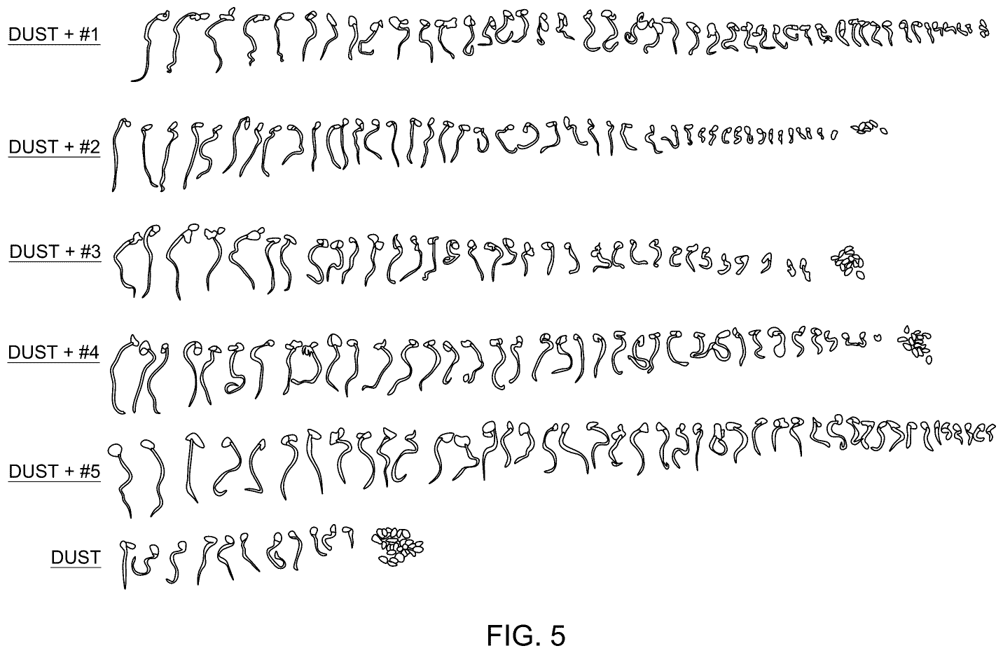

Specifically, Example 6 describes cotton seed treatment with each of compositions shown in Table 4 that contain one of seed performance compositions #1− #5 (shown in Table 3) in combination with either hydroxyethyl cellulose (HEC) or protein powder (DUST). The compositions were applied to seed as a dry seed treatment after liquid seed treatment with either a water control or a liquid blend of industry pesticides. FIG. 4 is an image showing germinated soybean seed first treated with a liquid inert control and then: not treated with a dry powder composition (None), treated with protein powder alone (Protein Powder), treated with hydroxyethyl cellulose alone (HEC), or treated with a composition including about 95-96.4% hydroxyethyl cellulose and about 3.4-5% of one of seed performance compositions #1− #5 from Tables 3 and 4 (HEC+ #1: HEC+ #2: HEC+ #3: HEC+ #4: HEC+ #5). The HEC+ #1 composition showed significant improvement (at 0.05 level) in seedling root growth as compared to the rest of the treatments (FIG. 4). FIG. 5 is an image showing germinated cotton first treated with a custom liquid blend of industry standard pesticide and then treated with either protein powder alone (DUST) or treated with a composition including about 95-96.4% protein powder DUST and about 3.4-5% of one of seed performance compositions #1− #5 from Tables 3 and 4 (DUST+ #1: DUST+ #2: DUST+ #3: DUST+ #4: DUST+ #5). As can be seen in FIG. 5, the DUST+ #5 composition exhibited the best improvement in seedling root growth.

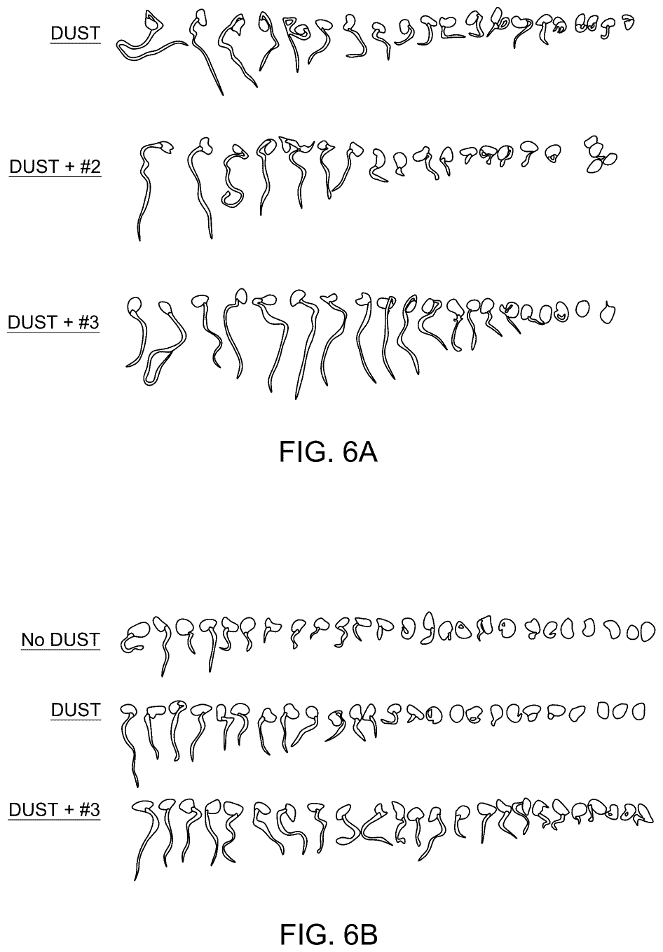

Example 7 describes soybean seed treatment with the compositions shown in Table 4 that contain one of seed performance compositions #1− #5 (shown in Table 3) in combination with protein powder (DUST). The compositions were applied to seed as a dry seed treatment after liquid seed treatment with either a water control or a liquid blend of industry pesticides. FIG. 6A is an image showing the germinated soy bean seed seven days after treatment with a liquid water control followed by treatment with protein powder alone (DUST) or treatment with a composition including about 95-96.4% DUST and about 3.4-5% of seed performance composition #2 (DUST+ #2) or #3 (DUST+ #3) from Tables 3 and 4. FIG. 6B is an image showing the germinated soybean seed seven days after treatment with a liquid blend of industry pesticides followed by no dry powder treatment (No DUST), treatment with protein powder alone (DUST), or treatment with a composition including about 95-96.4% DUST and about 3.4-5% of seed performance composition #3 (DUST+ #3) from Tables 3 and 4. The DUST+ #3 composition exhibited the best seedling growth promotion.

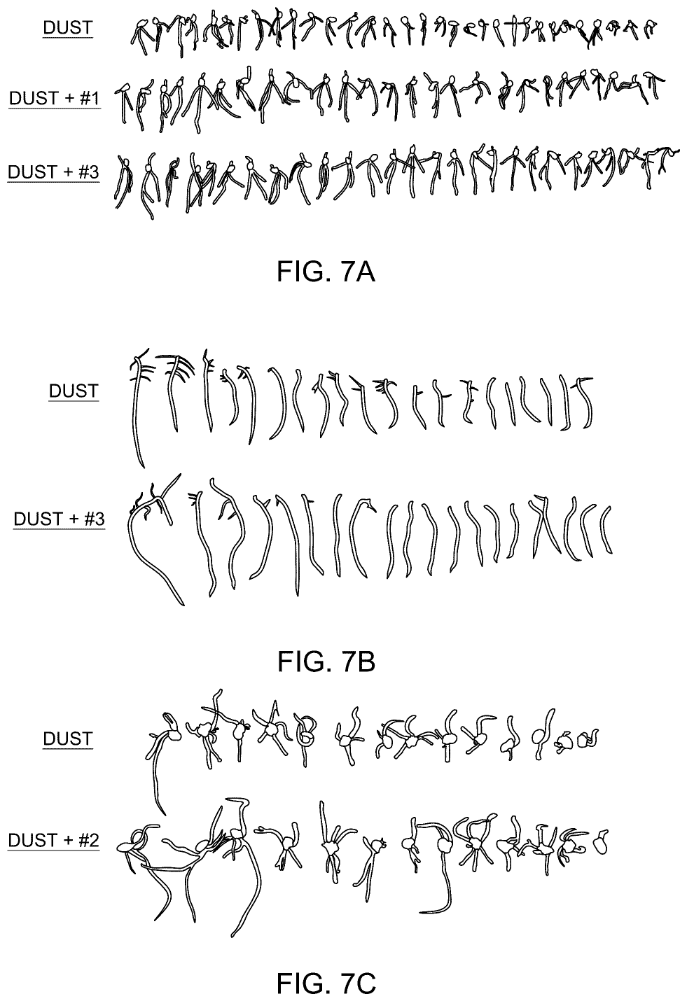

Example 8 describes treatment of wheat, yellow field pea, and corn seeds as described in Example 7 with one of the dry compositions in Table 4 containing one of seed performance compositions #1− #5 (shown in Table 3) in combination with protein powder (DUST), except that the pesticides were omitted from the liquid seed treatment in this set of experiments. FIG. 7A is an image showing germinated wheat seed seven days after treatment with a liquid water control followed by treatment with protein powder alone (DUST) or treatment with a composition including about 95-96.4% DUST and about 3.4-5% of seed performance composition #1 (DUST+ #1) or #3 (DUST+ #3). FIG. 7B is an image showing germinated pea seed seven days after treatment with a liquid water control followed by treatment with protein powder alone (DUST) or treatment with a composition including about 95% DUST and about 5% of seed performance composition #3 (DUST+#3). FIG. 7C is an image showing germinated corn seed seven days after treatment with a liquid water control followed by treatment with protein powder alone (DUST) or treatment with a composition including about 96% DUST and about 4% of seed performance composition #2 (DUST+ #2). As seen from the results, significant seedling root growth promotion resulted from seed treatment with DUST+ #3 in wheat and pea (FIGS. 7A & 7B, respectively). The DUST+ #2 formulation provided significant root enhancement in corn (FIG. 7C).

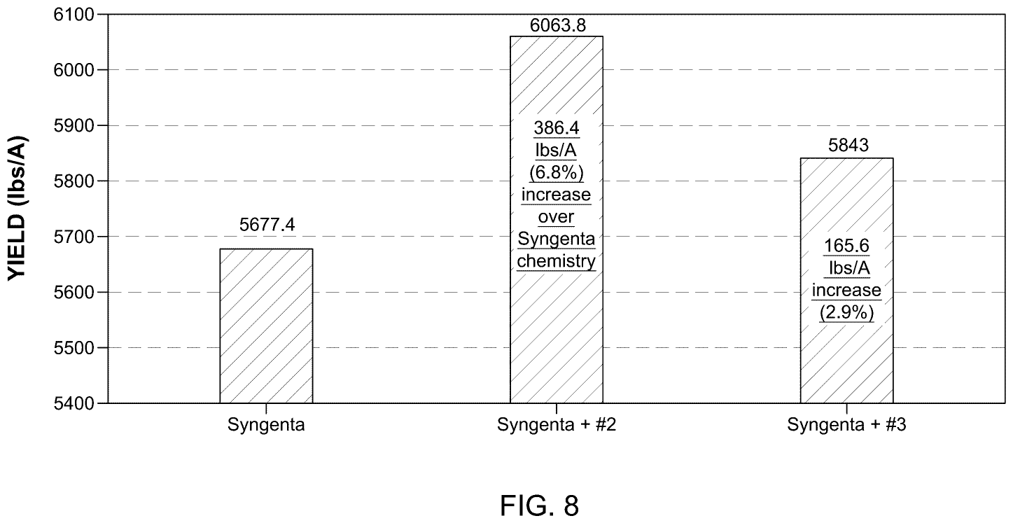

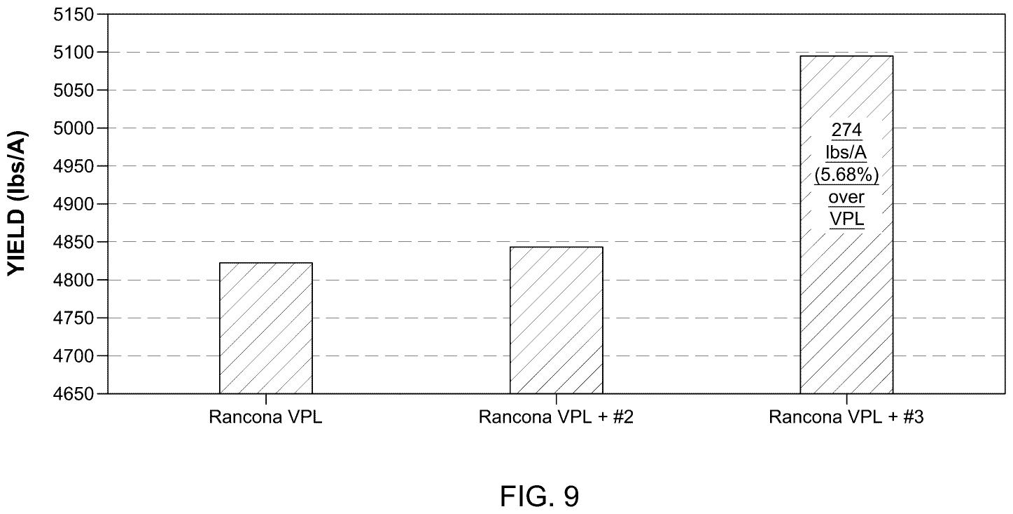

Example 9 describes large field plot trials with four replicates in Tifton, GA with peanut in a completely randomized design. The experiments showed that the seed performance compositions in Table 3 could counteract the negative effects on growth that are sometimes observed for seed treated with chemical pesticides. In one site. Syngenta liquid fungicide treated peanut seeds were over treated with seed performance dry composition #2 or #3 from Table 3. After harvest, the seed treated with liquid fungicide in addition to the #2 seed performance composition yielded 386.4 lbs (6.8%) more peanut per acre than the seed treated with Syngenta fungicides alone. The seed treated with liquid fungicide in addition to #3 seed performance composition generated 165.6 lbs (2.9%) more peanut than the seed treated with Syngenta fungicides alone (FIG. 8). In a second site, peanut seeds were first treated with UPL's RANCONA VPL liquid fungicide. Then seed performance compositions #2 or #3 from Table 3 were applied as over treatments on the RANCONA VPL chemistry. As can be seen in FIG. 9, seed treated with liquid fungicide and seed performance composition #3 yielded 274 lbs (5.68%) more peanut than seed treated with RANCONA VPL alone.

In some embodiments, the seed performance additive composition of the present disclosure includes, from about 35% to about 55% by weight of vitamin E: from about 17% to about 27% by weight of vitamin B1: from about 3.0% to about 11% by weight of vitamin C: from about 7.0% to about 11% by weight of glutathione; and optionally, one or more biostimulants. The composition can improve one or more metric of seed performance including reducing days to germination, increasing germination rate, and increasing plant growth. The seed performance additive composition can include one or both of biostimulants L-tryptophan and potassium humate. The one or both of biostimulants L-tryptophan and potassium humate can be present from about 8.0% to about 36% by weight.

In other embodiments, the seed performance additive composition of the present disclosure includes from about 35% to about 55% by weight of vitamin E: from about 17% to about 27% by weight of vitamin B1: from about 7.0% to about 11% by weight of glutathione; and from about 41% to about 38% by weight of potassium humate or the flavanone glycoside hesperidin. The composition can improve one or more metric of seed performance including reducing days to germination, increasing germination rate, and increasing plant growth.

The seed performance composition can be a composition comprising about 52.6% by weight of vitamin E, about 26% by weight of vitamin B1, about 10.5% by weight of vitamin C, and about 10.5% by weight of glutathione.

The seed performance composition can be a composition comprising about 43.5% by weight of vitamin E, about 21.7% by weight of vitamin B1, about 8.7% by weight of vitamin C, about 8% by weight of glutathione, about 8.7% by weight of L-tryptophan, and about 8.7% by weight of potassium humate.

The seed performance composition can be a composition comprising about 37% by weight of vitamin E, about 18.5% by weight of vitamin B1, about 7.4% by weight of glutathione, and about 37% by weight of isoflavonoid hesperidin.

The seed performance composition can be a composition comprising about 37% by weight of vitamin E, about 18.5% by weight of vitamin B1, about 7.4% by weight of glutathione, and about 37% by weight of potassium humate.

The seed performance composition can be a composition comprising about 35.7% by weight of vitamin E, about 17.8% by weight of vitamin B1, about 3.5% by weight of vitamin C, about 7% by weight of glutathione, and about 35.7% by weight of L-tryptophan.

The seed performance composition of the present disclosure can be formulated as a flowable liquid or as a dry composition.

In some embodiments, a dry composition is provided including: a seed flow lubricant and a seed performance additive, wherein the seed performance additive comprises: one or a combination of vitamin E, B1, and C: glutathione: optionally, a flavanone glycoside; and optionally, one or more biostimulants, wherein the dry composition improves one or more metric of seed performance including reducing days to germination, increasing germination rate, or increasing plant growth.

In the dry composition of the present disclosure, the seed performance additive can be any one of the seed performance additive compositions provided herein.

In the dry composition, the lubricant can include a cellulose-based polymer. The lubricant can be a dry cellulose-based polymer, protein powder, plant protein powder, talc, or graphite, and combinations thereof. The cellulose-based polymer can include, but is not limited to, one or more of hydroxyethyl cellulose (HEC), hydroxyethyl propyl methyl cellulose (HPMC), quillaja extract xanthan gum, or yucca extract, and combinations thereof. In other embodiments, the lubricant includes a protein powder or a plant protein powder.

The dry composition can be comprised of about 1.5-5% or about 3-5% by weight of the seed performance additive and about 95-98.5% or about 95-97%, respectively, of the remaining weight of the lubricant.

In some embodiments a plant seed is provided, the plant seed coated with a dry composition provided herein that includes both a seed performance additive and a seed flow lubricant.

In other embodiments a plant seed is provided, the plant seed coated with a seed performance composition provided herein.

Methods are also provided in the present disclosure. In one embodiment, a method is provided that includes applying a dry composition provided herein to a seed, wherein the dry composition comprises a seed flow lubricant provided herein, and a seed performance additive provided herein. In the method, the seed can have been treated with one or more pesticides. In an alternative embodiment, the method can further include applying one or more pesticides to the seed prior to applying the dry composition.

In another embodiment, a method is provided for improving seed performance. The method includes planting a seed treated with a seed performance composition or a dry composition that includes a seed performance composition and a seed flow lubricant of the present disclosure in a suitable growing medium, wherein the seed performance composition is present in an amount that improves one or more metric of seed performance including reducing days to germination, increasing germination rate, or increasing plant growth.

In addition to combination of the dry seed performance compositions of the present disclosure with dry seed lubricating powders such as, but not limited to, talc, graphite, protein powder, carbohydrate powder, or cellulose-based polymer powder, seed performance compositions can also be prepared as liquid formulations for application to seed. In some embodiments, the seed performance compositions of the present disclosure are formulated using water, solvent, or other liquid careers for use in liquid seed treatments. The dry seed performance compositions described herein can be mixed with other dry or liquid pesticide formulation and/with other plant growth promoting formulations for seed, foliar, and in-furrow applications.

Thus, in some embodiments, a method is provided for improving one or both of plant growth and health, comprising: delivering to seed of a plant, roots of a plant, or soil or growth medium surrounding a plant, a seed performance composition of the present disclosure, wherein the composition is present in an amount that improves one or more metric of seed performance including reducing days to germination, increasing germination rate, or increasing plant growth.

In the compositions and methods provided herein, the plant or plant seed can include, but is not limited to, soybean, peanut, corn, cotton, pea, wheat, cereal, grass, oil, legumes, non-legumes, or vegetable plants, and combinations thereof.

Following long-standing patent law convention, the terms “a,” “an,” and “the” refer to “one or more” when used in this application, including the claims. Thus, for example, reference to “a dry composition” includes a plurality of dry compositions, unless the context clearly is to the contrary, and so forth.

Throughout this specification and the claims, the terms “comprise,” “comprises,” and “comprising” are used in a non-exclusive sense, except where the context requires otherwise. Likewise, the terms “having” and “including” and their grammatical variants are intended to be non-limiting, such that recitation of items in a list is not to the exclusion of other like items that can be substituted or added to the listed items.

For the purposes of this specification and claims, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. In addition, as used herein, the term “about”, when referring to a value can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed compositions and methods. Where particular values are described in the application and claims, unless otherwise stated, the term “about” meaning within an acceptable error range for the particular value should be assumed. Specifically, in reference to the seed performance compositions provided herein, in some embodiments, the term “about” includes a meaning of a 100% increase or decrease in the values listed. Similarly, in reference to the seed performance compositions provided herein, in some embodiments, the term “about” includes a meaning of a 50% increase or decrease in the values listed.

### EXAMPLES

### Example 1

Soybean Seed Treatment with Cellulose-Based Polymer as Flowability Aid

The purpose of this experiment was to determine whether dry cellulose-based polymer could be used as a flowability aid for seed and to determine if it would also function to improve the appearance of seed. Alternative fluency aids generally used in the agricultural industry include talc, graphite, soy bean protein powder and other plant protein powders.

Soybean seed was first treated with a custom blend liquid base chemical treatment, KAN-SOY 252 ST, (Kannar Earth Science, Ltd., Lawrenceville, GA). Then the liquid chemical treated seed was contacted with a control and a test dry seed finisher formulation to compare the two. The control dry seed finisher composition was a product that contains soy protein powder and soy lecithin component as a lubricant to aid in flowability. The test dry seed finisher composition used in the experiment, was the same product formulation except that the soy protein powder and soy lecithin component was replaced with the cellulose-based polymer hydroxyethyl cellulose.

The soy bean seeds were treated in a ziplock bag. The KAN-SOY252 ST liquid base chemical treatment was applied using a syringe. The seed (500 g) was weighed out in a ziplock bag. The applicable amount of liquid slurry was weighed out in a syringe. The liquid slurry was shot into the ziplock bag onto the seeds. Total application rate of the liquid slurry was 5.5 Fl Oz/CWT. The bag was shaken for about 10 seconds. The bag was opened and the dry seed finisher (either test or control composition) was sprinkled over the seed using a plastic weigh boat. The application rate of the dry seed finisher was 0.8 Dry Oz/Unit of seed. The ziplock bag was closed again and shaken for about another minute. This was repeated for the control and test entries to ensure the same liquid treatment and timings were used to test the dry seed finishers against one another. A clean ziplock bag was used for each entry to ensure there was no cross contamination.

Treated soybean seed as described above was put through an apparatus designed for testing the comparable flowability of treated seed to determine if one test formulation resulted in a faster flow rate. An image showing the flowability funnels apparatus, also known as Cox funnels, from the front is shown in FIG. 1 and a top view of the apparatus is shown in FIG. 2. The flowability funnels apparatus consists of a metal stand and two funnels fitted with metal stoppers that can be pulled out at the same time to allow the seed loaded into the funnels to flow freely through the funnels. A clean container is set up beneath each funnel to catch the seed. The results from the soybean flow tests were as follows:

TABLE 1
Time for Soybean Seed to Flow Through Flowability Funnels

| Run Number | Control Composition | Test Composition |
|---|---|---|
| 1 | 12 Seconds | 11 Seconds |
| 2 | 12 Seconds | 11 Seconds |
| 3 | 13 Seconds | 12 Seconds |

As shown in Table 1, the samples that contained hydroxyethyl cellulose flowed faster than the samples that contained the soy protein powder and soy lecithin as a lubricant to aid in flowability. In addition, the hydroxyethyl cellulose did not hinder the appearance of the seed. In fact, the soybean seed treated with the test composition containing hydroxyethyl cellulose was shinier than seed treated with the control composition containing soy protein powder and soy lecithin as lubricant. FIGS. 3A and 3B show a comparison of images for the seed treated with the control (A) and test (3) seed compositions.

### Example 2

Peanut Seed Treatment with Cellulose-Based Polymer as Flowability Aid

Peanut seed was treated similarly as described above for soybean seed in Example 1 to test the effect on seed appearance by replacement of the soy protein powder and soy lecithin ingredient with hydroxyethyl cellulose. In this case, the liquid base chemical treatment used for the peanut seed was RANCONA VPL, a custom blend of pesticide components available direct to specialized customers via the company UPL. In this experiment, the control dry seed finisher was a different product formulation than in Example 1 that also contained soy protein powder and soy lecithin as a lubricant to aid flowability. The test formulation contained the same formulation except that the soy protein powder and soy lecithin component was replaced with hydroxyethyl cellulose. The appearance of the peanut seed that was treated with the dry seed finisher containing hydroxyethyl cellulose was not noticeably less shiny than the seed treated with control formulation containing soy protein powder and soy lecithin (image not shown).

### Example 3

Soybean Seed Treatment with Cellulose-Based Polymer as Flowability Aid

In this experiment, soybean seed was treated first with a liquid pesticide blend and then with a flowability aid consisting of cellulose-based polymer, soy protein powder, or a combination thereof.

Specifically, KANNAR SOY 252 ST was used as the base chemistry, e.g., pesticide mixture, for the soy bean seed treatments. It is a custom blend of pesticides including StartUp METXL 12.60%, StartUp IMIDA 30.71%, Rancona 3.8 FS 1.36%, StartUp T-MTYL 2.62%, colorant and binder 52.25% and water 0.46%. All of the soybean seed was treated with the pesticide blend at the same total application rate in a clean, dry, seed treatment machine known as a SedPell. The machine was cleaned out between each seed treatment to ensure no cross contamination. First, the untreated seed was put into the seed treatment machine. The machine was turned on to allow for the seed to start moving through the machine. The correct amount of the liquid pesticide custom blend was discharged over the untreated seed in the seed treatment machine utilizing a syringe. After the liquid slurry was applied to the seed, the dry seed finisher was applied overtop the seed in the seed treatment machine utilizing a small cup. The dry seed finisher (flowability aid) was applied at a rate of 0.800 Dry Oz/Unit for all entries. The total treatment time for all entries was 30 seconds. After the seed was allowed to dry, the seed was put through the flowability funnels, also known as Cox funnels, (shown in FIGS. 1 and 2) to compare how long it took for the seed to flow through.

Flowability Test utilizing 500 g of soybean seed for each entry

### Trial 1

| | Hydroxy | Soy | Time to Flow |
|---|---|---|---|
| Entry | Ethyl Cellulose | Protein | Through Funnels |
| 1 | | 100% | 7.59 Seconds |
| 2 | 100% | | 7.54 Seconds |

The entry utilizing 100% Hydroxy Ethyl Cellulose flowed 0.05 Seconds faster than the entry utilizing 100% Soy Protein.

### Trial 2

| | Hydroxy | Soy | Time to Flow |
|---|---|---|---|
| Entry | Ethyl Cellulose | Protein | Through Funnels |
| 1 | | 100% | 6.87 Seconds |
| 2 | 50% | 50% | 6.81 Seconds |

The entry that utilized a 50/50 blend of Hydroxy Ethyl Cellulose and Soy Protein flowed 0.06 Seconds faster than the entry utilizing 100% Soy Protein.

### Trial 3

| | Hydroxy | Soy | Time to Flow |
|---|---|---|---|
| Entry | Ethyl Cellulose | Protein | Through Funnels |
| 1 | 50% | 50% | 8.84 Seconds |
| 2 | 100% | | 7.74 Seconds |

The entry that utilized Hydroxy Ethyl Cellulose flowed 1.10 Seconds faster than the entry utilizing a 50/50 blend of Hydroxy Ethyl Cellulose and Soy Protein.

Flowability Test utilizing 1000 g of soybean seed for each entry

### Trial 1

| | Hydroxy | Soy | Time to Flow |
|---|---|---|---|
| Entry | Ethyl Cellulose | Protein | Through Funnels |
| 1 | | 100% | 12.40 Seconds |
| 2 | 100% | | 11.63 Seconds |

The entry that utilized Hydroxy Ethyl Cellulose flowed 0.77 Seconds faster than the entry that utilized Soy Protein.

### Example 4

Corn Seed Treatment with Cellulose-Based Polymer as Flowability Aid

KANNAR CORN IF 500 ST was used as the base chemistry, e.g., pesticide mixture, for the corn seed treatments. It is a custom ready to use blend of industry standard pesticides including StartUp TEBUZ 2.12%, StartUp METXL 4.76%, StartUp AZOXY 0.6%, Vitavax 34 25.39%, StartUP BIFEN 23.8%, colorant and binder 12.43%, KANTM7 13.16% and water 17.66%. All of the corn seed was treated with the pesticide blend at the same total application rate in a clean, dry, seed treatment machine known as a SedPell. The machine was cleaned out between each seed treatment to ensure no cross contamination. First, the untreated seed was put into the seed treatment machine. The machine was turned on to allow for the seed to start moving through the machine. The correct amount of the liquid pesticide custom blend was discharged over the untreated seed in the seed treatment machine utilizing a syringe. After the liquid slurry was applied to the seed, the dry seed finisher was applied overtop the seed in the seed treatment machine utilizing a small cup. The dry seed finisher was applied at a rate of 1.600 Fl Oz/Unit of seed for all entries. The total treatment time for all entries was 1 minute. After the seed was allowed to dry, the seed was put through the flowability funnels, also known as Cox funnels, (shown in FIGS. 1 and 2) to compare how long it took for the seed to flow through.

Flowability Test utilizing 1000 g of Corn seed for each entry

### Trial 1

| | No | Soy | Time to Flow |
|---|---|---|---|
| Entry | Fluency Aid | Protein | Through Funnels |
| 1 | 100% | | 19 Seconds |
| 2 | | 100% | 17 Seconds |

The entry that utilized Soy Protein flowed 2 Seconds faster than the entry that utilized no fluency aid.

### Trial 2

| | Hydroxy | Soy | Time to Flow |
|---|---|---|---|
| Entry | Ethyl Cellulose | Protein | Through Funnels |
| 1 | 100% | | 15 Seconds |
| 2 | | 100% | 16 Seconds |

The entry that utilized Hydroxy Ethyl Cellulose flowed 1 Second faster than the entry that utilized Soy Protein.

Trial 3

| | Hydroxy | | Time to Flow |
|---|---|---|---|
| Entry | Ethyl Cellulose | Talc | Through Funnels |
| 1 | 100% | | 18 Seconds |
| 2 | | 100% | 19 Seconds |

The entry that utilized Hydroxy Ethyl Cellulose flowed 1 Second faster than the entry that utilized Talc.

### Trial 4

| | Corn | | Tim to Flow |
|---|---|---|---|
| Entry | Starch | Talc | Through Funnels |
| 1 | 100% | | 15 Seconds |
| 2 | | 100% | 16 Seconds |

The entry that utilized Corn Starch flowed 1 Second faster than the entry that utilized

### Talc.

Trial 5

| | Hydroxy- | | |
|---|---|---|---|
| | Propyl- | | |
| | Methyl- | Soy | Time to Flow |
| Entry | Cellulose | Protein | Through Funnels |
| 1 | 100% | | 14 Seconds |
| 2 | | 100% | 15 Seconds |

The entry that utilized Hydroxy-Propyl-Methyl-Cellulose flowed 1 Second faster than the entry that utilized Soy Protein.

### Trial 6

| | Hydroxy- | | |
|---|---|---|---|
| | Propyl- | | |
| | Methyl- | | Time to Flow |
| Entry | Cellulose | Talc | Through Funnels |
| 1 | 100% | | 13 Seconds |
| 2 | | 100% | 17 Seconds |

The entry that utilized Hydroxy-Propyl-Methyl-Cellulose flowed 4 seconds faster than the entry that utilized talc.

The entries that utilized a cellulose-based flowability aid consistently performed as well as or better than industry standard flowability aids Talc and Soy Protein (see U.S. Pat. No. 10,426,077 for soy protein composition).

### Example 5

### Preparation of Seed Performance Compositions

Dry compositions were made as seed performance additives and as a combination of the seed performance additive and a seed flow lubricant composition by combining dry powders purchased from various sources and listed in Table 2.

TABLE 2
List of ingredients and their sources

| | |
|---|---|
| Tocopherol Vit E | Xi'an International healthcare Factory, China |
| Thiamine B1 | Xi'an Biohorlden Industry & Trading Co, China |
| Ascorbic Acid/C | Xi'an International healthcare Factory, China |
| Glutathione | Hunan Insen Biotech Co. Ltd., China |
| Tryptophan | Shaanxi Haibo Biotech Co, China |
| K-Humate | Humic Growth Solutions, USA |
| Hesperidin | Epin Biotech Co. Ltd, China |
| Protein powder, DUST | Low Mu Tech, USA |
| Hydroxyethyl | Ashland Speciality Chemicals, USA |
| Cellulose (HEC) | |

The seed performance additive compositions prepared using a specific percent dry weight of the powders listed in Table 2 are shown in Table 3 and identified as compositions #1 through #5.

TABLE 3
Seed performance additive compositions.

| | |
|---|---|
| Ingredient | Percent by Weight |

Seed Performance Additive Composition #1

| | |
|---|---|
| Tocopherol Vitamin E | 52.66 |
| Thiamine Vitamin B1 | 26.30 |
| Ascorbic Acid/Vitamin C | 10.52 |
| Glutathione | 10.52 |

Seed Performance Additive Composition #2

| | |
|---|---|
| Tocopherol Vitamin E | 43.51 |
| Thiamine Vitamin B1 | 21.73 |
| Ascorbic Acid/Vitamin C | 8.69 |
| Glutathione | 8.69 |
| L-Tryptophan | 8.69 |
| K-Humate | 8.69 |

Seed Performance Additive Composition #3

| | |
|---|---|
| Tocopherol Vitamin E | 37.05 |
| Thiamine Vitamin B1 | 18.50 |
| Glutathione | 7.40 |
| Hesperidin | 37.05 |

Seed Performance Additive Composition #4

| | |
|---|---|
| Tocopherol Vitamin E | 37.05 |
| Thiamine Vitamin B1 | 18.50 |
| Glutathione | 7.40 |
| K-Humate | 37.05 |

Seed Performance Additive Composition #5

| | |
|---|---|
| Tocopherol Vitamin E | 35.73 |
| Thiamine Vitamin B1 | 17.84 |
| Ascorbic Acid/Vitamin C | 3.57 |
| Glutathione | 7.14 |
| L-Tryptophan | 35.73 |

TABLE 4
Dry compositions including mixes of the seed performance additive
compositions shown in Table 3 with seed lubricating dry powder.

| Seed Performance | | Name of |
|---|---|---|
| Additive Composition | Seed Lubricating Powder | Combined |
| (% by weight) | (% by weight) | Composition |
| #1 − 3.4% | Hydroxyethyl Cellulose − 96.4% | HEC + #1 |
| #2 − 4.0% | Hydroxyethyl Cellulose − 96.0% | HEC + #2 |
| #3 − 5.0% | Hydroxyethyl Cellulose − 95.0% | HEC + #3 |
| #4 − 5.0% | Hydroxyethyl Cellulose − 95.0% | HEC + #4 |
| #5 − 5.0% | Hydroxyethyl Cellulose − 95.0% | HEC + #5 |
| #1 − 3.4% | Protein powder (DUST) − 96.4% | DUST + #1 |
| #2 − 4.0% | Protein powder (DUST) − 96.0% | DUST + #2 |
| #3 − 5.0% | Protein powder (DUST) − 95.0% | DUST + #3 |
| #4 − 5.0% | Protein powder (DUST) − 95.0% | DUST + #4 |
| #5 − 5.0% | Protein powder (DUST) − 95.0% | DUST + #5 |

### Example 6

Seed Treatment with Seed Performance+Lubricant Compositions

The purpose of this experimentation was to determine whether the dry combined compositions shown in Table 4 containing one of seed performance compositions #1− #5 (shown in Table 3) in combination with either hydroxyethyl cellulose (HEC) or protein powder (DUST) could enhance seed germination and seedling growth when applied as a dry seed treatment after liquid treatment with either a water control or a liquid blend of industry pesticides.

In one set of experiments, soybean seed was first treated with a blend of V005 polymer (manufactured by Kannar Earth Science Ltd.) colorant and water at a rate of 6.000 Fl Oz/CWT (CWT represents 100 pounds of seed). To treat the soybean seed with this liquid blend, the desired amount of seed was weighed out in a ziplock bag. For these experiments, 100 g of soybean seed was used for each entry. The correct amount of liquid slurry was weighed out into a syringe. This amount is determined using the total application rate of the blend (6.000 Fl Oz/CWT) and the amount of seed being treated. The liquid treatment was then applied to the seed in the ziplock bag by pressing the plunger of the syringe over the ziplock bag while moving the hand from side to side to ensure seed in all parts of the ziplock bag would be coated. The ziplock bag was shaken for about 10 seconds. It was then opened, and the first dry seed composition (selected from Table 4) was sprinkled over the seed using a plastic weigh boat. The application rate of the seed composition was 1.000 dry oz per unit of seed. The ziplock bag was closed again and shaken for about another 2 minutes. These steps were repeated for all entries, including all the dry seed compositions in Table 4 and the control of lubricant powder alone. The same liquid seed treatment, rate, and timings were used for every entry. A clean ziplock bag was used for each entry to ensure each entry would not be contaminated by any of the other treatments.

Next, the treated soybean seeds were plated in germination trays on moist germination paper and kept in the dark for 6 days at 22° C. FIG. 4 is an image showing the germinated soybean seed first treated with the liquid inert control and then: not treated with a dry powder composition (None), treated with protein powder alone (Protein Powder), treated with hydroxyethyl cellulose alone (HEC), or treated with a composition including about 95-96.4% hydroxyethyl cellulose and about 3.4-5% of one of seed performance compositions #1− #5 from Tables 3 and 4 (HEC+ #1: HEC+ #2: HEC+ #3: HEC+ #4: HEC+ #5). The HEC+ #1 composition showed significant improvement (at 0.05 level) in seedling root growth as compared to the rest of the treatments (FIG. 4).

In another set of experiments, cotton seed was first treated with a blend of industry standard pesticides, polymer, colorant, and water at a rate of 32.000 Fl Oz/CWT. To treat the cotton seed with this liquid blend, the desired amount of seed was weighed out in a ziplock bag. For these experiments, 100 g of cotton seed was used for each entry. The correct amount of liquid slurry was weighed out into a syringe. This amount is determined using the total application rate of the blend (32.000 Fl Oz/CWT) and the amount of seed being treated. The liquid chemical treatment was then applied to the seed in the ziplock bag by pressing the plunger of the syringe over the ziplock bag while moving the hand from side to side to ensure seed in all parts of the ziplock bag would be coated. The ziplock bag was shaken for about 10 seconds. It was then opened, and the first dry seed composition (selected from Table 4) was sprinkled over the seed using a plastic weigh boat. The application rate of the seed composition was 1 dry oz per unit of seed. The ziplock bag was closed again and shaken for about another 2 minutes. These steps were repeated for all entries, including all the dry seed compositions in Table 4 and the control of dry lubricant powder alone. The same liquid seed treatment, rate, and timings were used for every entry. A clean ziplock bag was used for each entry to ensure each entry would not be contaminated by any of the other treatments.

Next, the treated cotton seeds were plated in germination trays on moist germination paper and kept in the dark for 6 days at 22° C. and cotton seedling root growth parameters were measured from treatments with the various seed performance compositions #1− #5 in combination with either HEC or DUST from Table 4 (see FIG. 5).

FIG. 5 shows the germinated cotton seed first treated with the custom liquid blend of industry standard pesticide and then treated with either with protein powder alone (DUST) or treated with a composition including about 95-96.4% protein powder DUST and about 3.4-5% of one of seed performance compositions #1− #5 from Tables 3 (DUST+ #1: DUST+ #2: DUST+ #3: DUST+ #4; DUST+ #5). As can be seen in FIG. 5, the DUST + #5 composition exhibited the best improvement in seedling root growth.

The results of these experiments show that the plant growth promotion effect of the dry compositions in Table 4 differs depending on the type of seed lubricating dry powder used (here, HEC and protein powder DUST).

### Example 7

Soybean Seed Treatment with Seed Performance+Lubricant Compositions

The purpose of this experimentation was to determine whether the dry compositions shown in Table 4 containing a combination of one of the seed performance compositions #1− #5 (shown in Table 3) and dry protein powder DUST could enhance seed germination and seedling growth when applied as a dry seed treatment after liquid treatment with either a water control or a liquid blend of industry pesticides.

In these experiments, soy bean seeds were first treated with liquid treatment Kannar Soy 252 ST vl.0 (KAN-SOY 252 ST) at a rate of 5.500 Fl Oz/CWT. KAN-SOY 252 ST which is a custom blend of industry standard pesticides, polymer and colorant (FIG. 6A). Also, a control liquid seed treatment was performed in which the pesticides were left out (FIG. 6B). To treat the soybean seed with KAN-SOY 252 ST or the control liquid with pesticides omitted, the desired amount of seed was weighed out in a ziplock bag. For these experiments, 100 g of soybean seed was used for each entry. The correct amount of KAN-SOY 252 ST or control liquid was weighed out into a syringe. This amount is determined using the total application rate of the blend (5.500 Fl Oz/CWT) and the amount of seed being treated. The liquid treatment was then applied to the seed in the ziplock bag by pressing the plunger of the syringe over the ziplock bag while moving the hand from side to side to ensure seed in all parts of the ziplock bag would be coated. The ziplock bag was shaken for about 10 seconds. It was then opened, and the first dry seed composition (from Table 4) was sprinkled over the seed using a plastic weigh boat. The application rate of the seed composition was 1 dry oz per unit of seed. The ziplock bag was closed again and shaken for about another minute. These steps were repeated for all entries, including all the dry seed compositions (DUST+ #1− #5 in Table 4) and a control dry composition containing only DUST. The same liquid seed treatment, rate, and timings were used for every entry. A clean ziplock bag was used for each entry to ensure each entry would not be contaminated by any of the other treatments.

The treated soybean seeds were plated in germination trays on moist germination paper and kept in the dark for 7 days at 22° C. and soy bean seedling root growth parameters were measured. FIG. 6A is an image showing the germinated soybean seed seven days after treatment with the liquid water control followed by treatment with protein powder alone (DUST) or treatment with a composition including about 95-96.4% DUST and about 3.4-5% of seed performance composition #2 (DUST+ #2) or #3 (DUST+ #3) from Tables 3 and 4. FIG. 6B is an image showing the germinated soybean seed seven days after treatment with the liquid blend of industry pesticides followed by no dry powder treatment (No DUST), treatment with protein powder alone (DUST), or treatment with a composition including about 95-96.4% DUST and about 3.4-5% of seed performance composition #3 (DUST+ #3) from Tables 3 and 4. The DUST+ #3 composition exhibited the best seedling growth promotion.

### Example 8

Wheat, Pea, and Corn Seed Treatment with Seed Performance+Lubricant Compositions

Crop seeds wheat, yellow field pea, and corn seeds were treated according to the treatment procedures in Example 7, without the pesticides and the results are shown in FIGS. 7A-7C. Only the best plant growth response was recorded from visual appearance. FIG. 7A is an image showing germinated wheat seed seven days after treatment with a liquid water control followed by treatment with protein powder alone (DUST) or treatment with a composition including about 95-96.4% DUST and about 3.4-5% of seed performance composition #1 (DUST+ #1) or #3 (DUST+ #3) from Tables 3 and 4. FIG. 7B is an image showing germinated pea seed seven days after treatment with a liquid water control followed by treatment with protein powder alone (DUST) or treatment with a composition including about 95% DUST and about 5% of seed performance composition #3 (DUST+#3) from Tables 3 and 4. FIG. 7C is an image showing germinated corn seed seven days after treatment with a liquid water control followed by treatment with protein powder alone (DUST) or treatment with a composition including about 96% DUST and about 4% of seed performance composition #2 (DUST+ #2) from Tables 3 and 4. As seen from the results, significant seedling root growth promotion resulted from seed treatment with DUST+ #3 in wheat and pea (FIGS. 7A & 7B, respectively). The DUST+ #2 formulation provided significant root enhancement in corn (FIG. 7C).

In summary, when all the experiments and results were compiled together, a picture is depicted that shows the specific compositions that worked best for specific crops (Table 5).

TABLE 5
Effect of seed performance composition #1 with Hydroxyethyl
cellulose powder on cotton seedling root growth. Values separated
by different letters are significantly different at 0.05 level.

| | | Protein | | HEC + |
|---|---|---|---|---|
| Growth Parameters | Control | Powder | HEC | #1 |
| Average root length (cm) | 6.20b | 5.85b | 6.72b | 8.73a |
| Root volume (cm3) | 0.077b | 0.0756b | 0.087b | 0.120a |
| Root number | 3.5bb | 3.3b | 3.5b | 6.7a |
| Total root fresh weight (g) | 1.889b | 1.904b | 2.11b | 3.084a |

TABLE 6
Significant (at 0.05 level) seedling root growth
promoted by combinations of specific dry seed
performance compositions and lubricant powders.

| | Seed lubricant | | | | | |
|---|---|---|---|---|---|---|
| Crop | powder | #1 | #2 | #3 | #4 | #5 |
| Cotton | HEC | + | − | − | − | − |
| Cotton | DUST | − | − | − | − | + |
| Soybean | DUST | − | − | + | − | − |
| (with pesticides) | | | | | | |
| Soybean | DUST | − | − | + | − | − |
| Wheat | DUST | | | + | − | − |
| Yellow Pea | DUST | − | − | + | − | − |
| Corn | DUST | − | + | − | − | − |

### Example 9

Peanut Seed Treatment with Seed Performance Compositions in Field Trials

Large field plot trials with 4 replicates were conducted by University of Georgia Extension at Tifton, GA with peanut in a completely randomized design. The experiments tested whether the seed performance compositions in Table 3 could counteract the negative effects on growth that are sometimes observed for seed treated with chemical pesticides.

In one site at the Tifton location, Syngenta liquid fungicide treated peanut seeds were over treated with seed performance dry composition #2 or #3 from Table 3. After harvest, the seed treated with liquid fungicide in addition to the #2 seed performance composition yielded 386.4 lbs (6.8%) more peanut per acre than the seed treated with Syngenta fungicides alone. The seed treated with liquid fungicide in addition to #3 seed performance composition generated 165.6 lbs (2.9%) more peanut than the seed treated with Syngenta fungicides alone (FIG. 8).

In a second site at the Tifton location, peanut seeds were first treated with UPL's RANCONA VPL liquid fungicide. Then seed performance compositions #2 or #3 from Table 3 were applied as over treatments on the RANCONA VPL chemistry. As can be seen in FIG. 9, seed treated with liquid fungicide and seed performance composition #3 yielded 274 lbs (5.68%) more peanut than seed treated with RANCONA VPL alone.

Accordingly, while the compositions and methods have been described in reference to specific embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the elements and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

What is claimed is:

1. A method comprising:
applying a dry composition to a seed, wherein the dry composition comprises a seed flow lubricant and a seed performance additive, wherein the seed performance additive comprises:
i. one or a combination of vitamin E, B1, and C;
ii. glutathione;
iii. optionally, a flavanone glycoside; and
iv. optionally, one or more biostimulants,
wherein the dry composition improves one or more metric of seed performance including reducing days to germination, increasing germination rate, or increasing plant growth.

2. The method of claim 1, wherein the lubricant comprises a cellulose-based polymer.

3. The method of claim 2, wherein the cellulose-based polymer comprises one or more of hydroxyethyl cellulose, hydroxyethyl propyl methyl cellulose (HPMC), quillaja extract xanthan gum, or yucca extract, and combinations thereof.

4. The method of claim 1, wherein the seed has been treated with one or more pesticides.

5. The method of claim 1, further comprising applying one or more pesticides to the seed prior to applying the dry composition.

6. The method of claim 1, wherein the seed performance additive comprises about 1.5-5% by weight of the dry composition and the lubricant comprises the remaining about 95-98.5% by weight of the dry composition.

7. The method of claim 1, wherein the seed performance additive comprises:
a. from about 35% to about 55% by weight of vitamin E;
b. from about 17% to about 27% by weight of vitamin B1;
c. from about 3.0% to about 11% by weight of vitamin C; and
d. from about 7.0% to about 11% by weight of glutathione.

8. The method of claim 1, wherein the seed performance additive comprises:
a. from about 35% to about 55% by weight of vitamin E;
b. from about 17% to about 27% by weight of vitamin B1;
c. from about 7.0% to about 11% by weight of glutathione; and
d. from about 41% to about 38% by weight of potassium humate or the flavanone glycoside hesperidin.

9. A dry composition comprising: a seed flow lubricant and a seed performance additive, wherein the seed performance additive comprises:
i. one or a combination of vitamin E, B1, and C;
ii. glutathione;
iii. optionally, a flavanone glycoside; and
iv. optionally, one or more biostimulants,
wherein the dry composition improves one or more metric of seed performance including reducing days to germination, increasing germination rate, and increasing plant growth.

10. The dry composition of claim 9, wherein the lubricant comprises a cellulose-based polymer.

11. The dry composition of claim 10, wherein the cellulose-based polymer comprises one or more of hydroxyethyl cellulose (HEC), hydroxyethyl propyl methyl cellulose (HPMC), quillaja extract xanthan gum, or yucca extract, and combinations thereof.

12. The dry composition of claim 9, wherein the seed performance additive comprises about 1.5-5% by weight of the dry composition and the lubricant comprises the remaining about 95-98.5% by weight of the dry composition.

13. The dry composition of claim 9, wherein the seed performance additive comprises:
a. from about 35% to about 55% by weight of vitamin E;
b. from about 17% to about 27% by weight of vitamin B1;
c. from about 3.0% to about 11% by weight of vitamin C; and
d. from about 7.0% to about 11% by weight of glutathione.

14. The dry composition of claim 9, wherein the seed performance additive comprises:
a. from about 35% to about 55% by weight of vitamin E;
b. from about 17% to about 27% by weight of vitamin B1;
c. from about 7.0% to about 11% by weight of glutathione; and
d. from about 41% to about 38% by weight of the potassium humate or the flavanone glycoside hesperidin.

15. A plant seed coated with a dry composition comprising a seed flow lubricant and a seed performance additive, wherein the seed performance additive comprises:
i. one or a combination of vitamin E, B1, and C;
ii. glutathione;
iii. optionally, a flavanone glycoside; and
iv. optionally, one or more biostimulants,
wherein the dry composition improves one or more metric of seed performance including reducing days to germination, increasing germination rate, or increasing plant growth.

16. The plant seed of claim 15, wherein the lubricant comprises a cellulose-based polymer.

17. The plant seed of claim 16, wherein the cellulose-based polymer comprises one or more of hydroxyethyl cellulose, hydroxyethyl propyl methyl cellulose (HPMC), quillaja extract xanthan gum, or yucca extract, and combinations thereof.

18. The plant seed of claim 15, wherein the seed performance additive comprises about 1.5-5% by weight of the dry composition and the lubricant comprises the remaining about 95-98.5% by weight of the dry composition.

19. The plant seed of claim 15, wherein the seed performance additive comprises:
a. from about 35% to about 55% by weight of vitamin E;
b. from about 17% to about 27% by weight of vitamin B1;
c. from about 3.0% to about 11% by weight of vitamin C; and
d. from about 7.0% to about 11% by weight of glutathione.

20. The plant seed of claim 15, wherein the seed performance additive comprises:
a. from about 35% to about 55% by weight of vitamin E;
b. from about 17% to about 27% by weight of vitamin B1;
c. from about 7.0% to about 11% by weight of glutathione; and
d. from about 41% to about 38% by weight of the potassium humate or the flavanone glycoside hesperidin.
